(19) United States
(12) Patent Application Publication
(10) Pub. No.: US 2022/0087898 A1
(43) Pub. Date: Mar. 24, 2022

(54) SYSTEM, DEVICE AND METHOD TO AID GAIT AND BALANCE IN ATAXIC USERS

(71) Applicant: Daniel Arthur Reynolds, Montclair, VA (US)

(72) Inventor: Daniel Arthur Reynolds, Montclair, VA (US)

(21) Appl. No.: 17/445,039

(22) Filed: Aug. 13, 2021

Related U.S. Application Data
(60) Provisional application No. 63/198,021, filed on Sep. 24, 2020.

(51) Int. Cl. A61H 23/02

(52) U.S. Cl. CPC A61H 23/02; A61H 2205/088; A61H 2201/164; A61H 2201/165; A61H 2205/106

(57) ABSTRACT

A system and method for aiding wearers with ataxia. The system and method embodying removably positioning vibratory devices adjacent to just above each hip bone of the wearer and adjacent to each ankle of the wearer. The vibratory devices can be selectively and programmatically controlled to provide haptic signals for improving proprioception and thereby improving the gait and balance of the wearer.

### CROSS-REFERENCE TO RELATED APPLICATION

This application claims the benefit of priority of U.S. provisional application No. 63/198,021, filed 24 Sep. 2020, the contents of which are herein incorporated by reference.

### BACKGROUND OF THE INVENTION

The present invention relates to medical and therapeutic devices and, more particularly, a system, device, and method to aid gait and balance for ataxic walkers.

Ataxia is a clinical manifestation indicating dysfunction of the nervous system that comprises lack of voluntary coordination of muscle movements that can include gait abnormality and loss of balance. Individuals with ataxia have increased difficulty with gait and balance when trying to walk and stand.

Existing options and solutions are inadequate in addressing this condition. Current devices for addressing ataxia include orthotic shoe inserts. While shoe inserts may be helpful, they require office visits and custom orthotic inserts to be made. Even more generally, they require the wearing of shoes, and so individuals who are barefoot are out of luck. Furthermore, orthotics wear out over time, thereby requiring re-fitting, re-ordering, and more office visits.

As can be seen, there is a need for a system, device, and method to aid gait and balance for ataxic walkers. The present invention provides a shoeless solution that assists all who may have this condition. The present invention is easily worn and may be configured to the needs of each ataxic user to improve their gait and balance. Accordingly, the solution is an improvement over other solutions as it does not require custom fitting and can be used while barefoot.

The present invention includes a vibratory device providing haptic signals to the extremities and trunk of the wearer, improving their proprioception and thereby improving gait and balance in a bespoke manner, as the user can selectively and programmatically control the haptic signals. It is believed that vibrations stimulate the large nerve bundles in the extremities and trunk which aid in proprioception.

### SUMMARY OF THE INVENTION

In one aspect of the present invention, a method of aiding wearers with ataxia, the method including positioning a vibratory device adjacent to each ankle, wherein each vibratory device outputs haptic signals for improving proprioception of the wearer, whereby improving gait and balance.

In other embodiments, the method includes positioning additional vibratory devices adjacent to both iliac crests and selectively controlling a controller for powering said output haptic signals.

In another aspect of the present invention, a system for ataxia walkers, the system includes the following: a waistband having one or more waist retainers; each waist retainer adapted to retain a vibratory device adjacent to a waist area just above one of the left or right hip bones of a wearer, wherein each vibratory device outputs haptic signals improving proprioception of the wearer, whereby improving gait and balance of the wearer; an ankle strap, each ankle strap having one or more ankle retainers; each ankle retainer adapted to retain another vibratory device adjacent to each ankle; a controller for selectively controlling said output haptic signals.

In yet another aspect of the present invention, a method of aiding wearers with ataxia includes the following: positioning a vibratory device adjacent to a waist area just above each hip bone of a wearer, wherein each vibratory device outputs haptic signals for improving proprioception of the wearer, whereby improving gait and balance of the wearer; positioning an additional vibratory device adjacent an ankle area adjacent to each ankle of the wearer; selectively controlling a controller for powering said output haptic signals, wherein each waist area is adjacent to and just behind opposing iliac crests of the wearer, and wherein each ankle area is adjacent each ankle.

In yet another aspect of the present invention, a system for ataxia walkers includes the following: a waistband having two waist retainers; each waist retainer adapted to retain a vibratory device adjacent to a waist area just above a hip bone of a wearer, wherein each vibratory device outputs haptic signals improving proprioception of the wearer, whereby improving gait and balance of the wearer; two ankle straps, each ankle strap having a ankle retainer; each ankle retainer adapted to retain another vibratory device adjacent to an ankle of the wearer; a controller for selectively controlling said output haptic signals; one or more insertable weights in one or more pockets of the waistband, wherein each waist area is adjacent to and just behind a respective iliac crest.

These and other features, aspects and advantages of the present invention will become better understood with reference to the following drawings, description and claims.

### BRIEF DESCRIPTION OF THE DRAWINGS

FIG. 1 is an elevation view of an exemplary embodiment of the present invention, shown in use.

FIG. 2 is an elevation view of an exemplary embodiment of an ankle wrap of the present invention.

FIG. 3 is an exploded elevation view of an exemplary embodiment of the ankle wrap of the present invention.

FIG. 4 is an elevation view of an exemplary embodiment of a vibratory device of the present invention.

FIG. 5 is a perspective view of an exemplary embodiment of the waistband of the present invention.

FIG. 6 is an elevation view of an exemplary embodiment of a remote control of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system, device, and method to aid gait and balance in ataxic persons.

Individuals with ataxia have difficulty walking and balancing. The present invention provides a system configurable to the needs of the individual user, through vibratory devices selectively providing vibratory output to a user's lower extremities and waist/trunk, thereby improving the wearer's balance and gait. This system may incorporate ankle wraps and waistband, both with pockets, wherein vibratory devices are secured in the pockets. The systemic vibratory devices may be wirelessly controlled, and the remote controller may be in one of the pockets for manual implementation.

In an exemplary embodiment, the system of the present invention uses commercially available products and repurposes them in a unique way to address a heretofore long-felt need. For instance, each ankle component and the waistband may be repurposed exercise/fitness equipment—e.g., the waist band may be a running belt having pockets fillable with removable weights, and the ankle components may be ankle weight wraps with pockets for the same reason. Such pre-existing equipment may be repurposed by removing the weights and replacing them with the systemic vibratory devices in said pockets. The vibratory devices also being commercially available.

The ankle bands and waistband may be adjustably secured to the user's ankles and waistband, respectively, through various removable fasteners. Such as, but not limited, hook and loop fasteners, snaps, reusable adhesives and the like.

Each vibratory device may be operatively associated with the remote control. The vibratory devices may all be controlled by a single remote controller. The vibratory devices have several settings, which are determined by the model of vibrator provided.

Further, to the extent the present application discloses a method, a system of apparatuses configured to implement the method are within the scope of the present invention.

The vibratory program may be user-selectable and programmable for each user's best results. The device of the present invention requires little maintenance, as it may just require replacement of over-the-counter batteries or recharging, depending on the type the user selects.

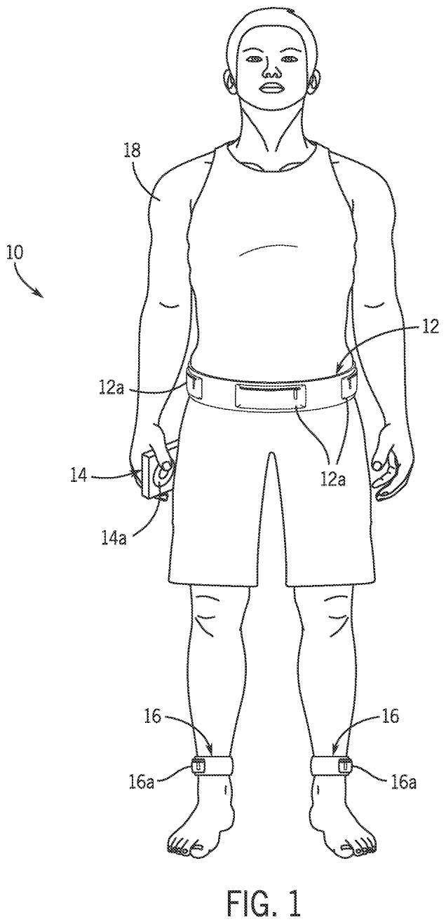

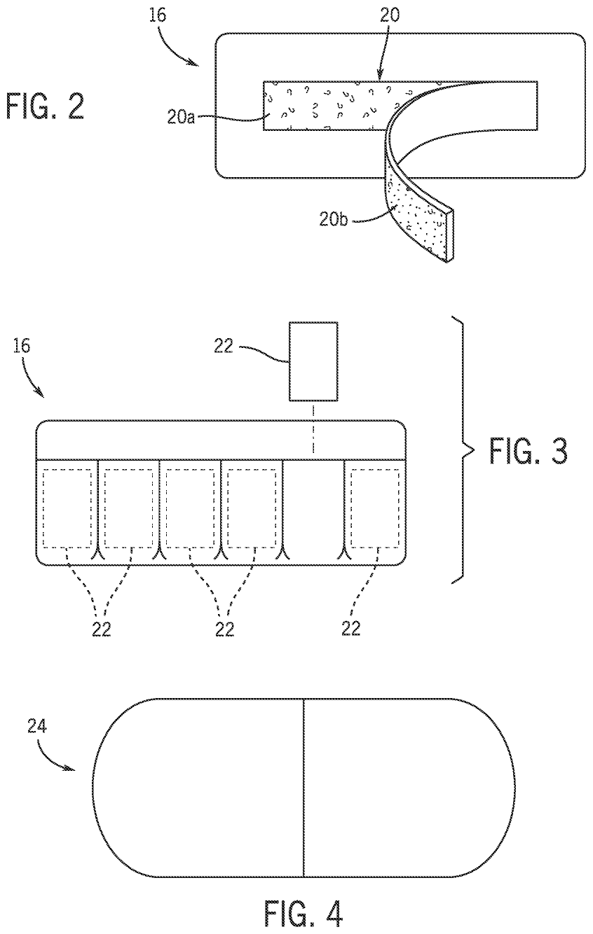

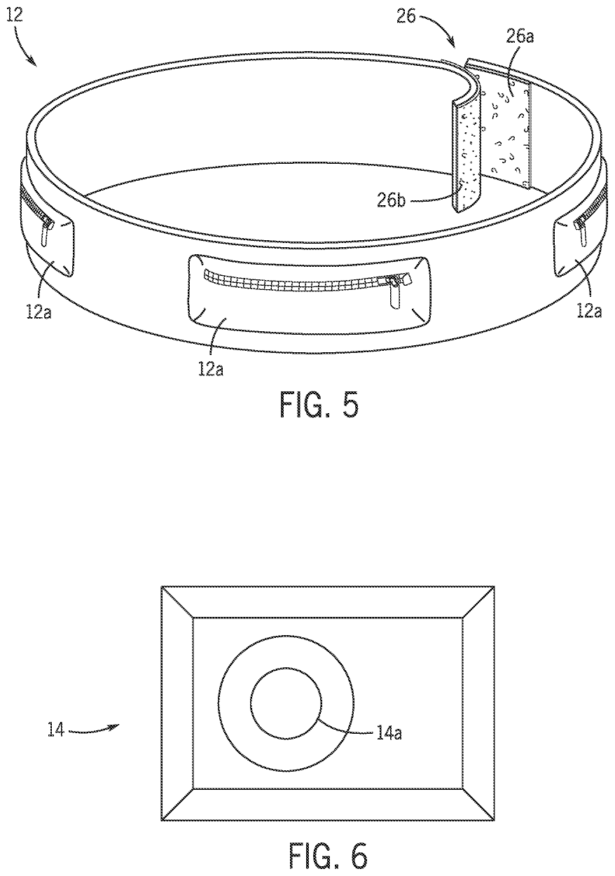

Referring now to FIG. 1-6, the ataxia aid system 10 embodied in the present invention may include the following systemic components:
1. A waistband 12 having two or more waist pockets 12a, wherein the waistband has one or more detachable fasteners 20 for removability and adjustably securing the waistband 12 around the waist of a user 18.
2. Two ankle wraps 16, each ankle wrap 16 having one or more pockets 16a, wherein each ankle wrap 16 has one or more detachable fasteners 26 for removability and adjustably securing the ankle wrap 16 around the ankle of the user 18.
3. Each ankle wrap may have one vibratory device; each waistband may have two vibratory devices 24, wherein each of the vibratory devices 24 may be wirelessly controlled by a singular device.
4. A remote control 14 for wirelessly controlling each of the one or more vibratory devices 24, wherein there is a switch configured to cycle though the various pre-programmed settings. Each remote control 14 has a power source, such as batteries or the like.

Each detachable fasteners 20 and 26 may have complementary first and second portions 20a/20b and 26a/26b, respectively, to facilitate the removability and the adjustability. In certain embodiments, the first and second portions 20a/20b and 26a/26b may be hook portions and loop portions of hook and loop fasteners; though it is understood that other detachable fasteners may be used as long as they function as disclosed herein. By way of example, snaps, zipper, re-applicable adhesives and the like may be used for the detachable fasteners 20 and 26.

Furthermore, the present invention does not necessarily need “pockets” but just needs a component adapted to secure the vibratory devices 24 adjacent to the respective waistband 12 and/or the ankle wrap 16. Accordingly, straps, magnets, adhesive, or the like can be used in lieu of pockets 12a and 16a. In certain embodiments, the waistband 12 pockets 12a may be at least disposed adjacent to and just above the hip bone one each side (left and right) of the user/wearer 18.

In some embodiments, weights 22 may either be provided for balancing aids, wherein the weights 22 are dimensioned and adapted to be housed in each pocket 12a and 16a. Alternatively, the weights 22 may be removed from a commercially available running belt and/or fitness ankle wraps and replaced by the systemic vibratory devices 24 in a method of making the present invention.

A method of using the present invention may include the following. The ataxia aid system 10 disclosed above may be provided. The user 18 may place the waistband 12 about their waist so that the (waistband pockets 12a and housed) waistband vibratory devices 24 are adjacent to and just above each hip bone of the wearer-user 18. The user 18 may place an ankle wrap 16 about each ankle so that the (ankle wrap pockets 16a and housed) waistband vibratory devices 24 are adjacent to the ankle of the wearer-user 18. After donning the ankle wraps 16 and/or waistband 12, the vibratory device 24 may be activated by pressing the power button on the remote control 14. The remote control 14 may be programmed to selectively cycling through the available pre-programmed modes of the vibratory devices 24. The user 18 may use the remote control 14 to activate the vibratory devices 24 and select the program/mode which provides the best improvement in balance and gait.

In another embodiment, the user 18 may place one ankle wrap 16 on each ankle with the vibratory device 24 placed as best works for the user. The user 18 may don the waistband 12, positioning its vibratory devices 24 to be adjacent to the iliac crest (top of the hip bone) toward the outside.

In certain embodiments, it may be possible to program and have printed PCB boards that would have a smaller footprint than the ‘wireless remotely controlled vibratory devices’, as long as the devices provided sufficient output of haptic signals in terms of frequency, direction, power, etc. (although a housing for the variable speed DC-motor may need to be fashioned).

Additionally, each component of the present invention may be used, in different ways. The ankle wraps 16 and/or the waistband 12 may be weighted by the weight inserts 22 for balancing, strengthening and exercise purposes used to further aid the ataxia user 18.

In summary, the present invention may provide a device to aid gait and balance in ataxic persons. The ataxia aid system 10 may use commercially available products and repurpose them in a unique way to address a heretofore unaddressed need. The device may use ankle wraps with removable weights, and substitute commercially available wireless remotely controlled vibratory devices in the pockets in place of the weights. The wireless remotely controlled vibratory devices may be placed inside pockets of a commercially available running belt for the waist implementation.

For clarity, only those aspects of the system germane to the present invention are described, and product details well known in the art are omitted. In addition, many embodiments of the present invention have application to a wide range of industries. To the extent the present application discloses a system, the method implemented by that system is within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of aiding wearers with ataxia, the method comprising:
positioning a vibratory device adjacent to a waist area just above each hip bone of a wearer, wherein each vibratory device outputs haptic signals for improving proprioception of the wearer, whereby improving gait and balance of the wearer.

2. The method of claim 1, further comprising positioning an additional vibratory device adjacent an ankle area adjacent to each ankle of the wearer.

3. The method of claim 2, further comprising selectively controlling a controller for powering said output haptic signals.

4. The method of claim 3, wherein each waist area is adjacent to and just behind opposing iliac crests of the wearer.

5. The method of claim 4, wherein each ankle area is adjacent each ankle.

6. A system for ataxia walkers, the system comprising:
a waistband having two waist retainers;
each waist retainer adapted to retain a vibratory device adjacent to a waist area just above a hip bone of a wearer, wherein each vibratory device outputs haptic signals improving proprioception of the wearer, whereby improving gait and balance of the wearer.

7. The system of claim 6, further comprising:
two ankle straps, each ankle strap having a ankle retainer;
each ankle retainer adapted to retain another vibratory device adjacent to an ankle of the wearer.

8. The system of claim 7, further comprising a controller for selectively controlling said output haptic signals.

9. The system of claim 8, further comprising one or more insertable weights in one or more pockets of the waistband.

10. The system of claim 9, wherein each waist area is adjacent to and just behind a respective iliac crest.
